(19) United States
(12) Patent Application Publication
(10) Pub. No.: US 2008/0091887 A1
(43) Pub. Date: Apr. 17, 2008

(54) MEMORY CONTROLLER GENERATING A DATA VALUE

(76) Inventors: Matthew B. Dumm, Fort Collins, CO (US); Gregory W. Thelen, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/549,711

(22) Filed: Oct. 16, 2006

(51) Int. Cl. G06F 12/00

(52) U.S. Cl. 711/150

(57) ABSTRACT

A memory controller for generating a data value and a method of generating the data value at a memory controller are described. The memory controller comprises an address resolver for receiving a data value request from a requester. The data value request comprises a memory address and the address resolver arranged to determine if the memory address is within a predetermined set of memory addresses. The memory controller comprises a value generator for generating a data value based on a data value request determined to comprise a memory address within the predetermined set of memory addresses. The method comprises receiving a data value request where the request comprises a memory address, determining if the memory address of the request is within a predetermined memory address set, and generating a data value based on the request determined to comprise a memory address within the predetermined memory address set.

### BACKGROUND

In order to create a range of memory filled with all zeroes or a repeating pattern of values for use with an executable sequence of instructions, e.g., a software program or executable, the required memory must be allocated and every piece of memory initialized with a write from a processor or by other means. This process requires the physical memory resource along with time and system performance, e.g., addressing and data bandwidth, to perform the initializing writes to memory.

If a read request from a memory controller specifies a memory address outside the range of addresses within physical memory, the memory controller generates and transmits an error message to the memory requester.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level functional block diagram of a portion of a system in which an embodiment can be used to advantage;

FIG. 2 is a high level process flow diagram according to an embodiment;

FIG. 3 is a message sequence diagram of operation of an embodiment; and

FIG. 4 is another message sequence diagram of operation of an embodiment.

### DETAILED DESCRIPTION

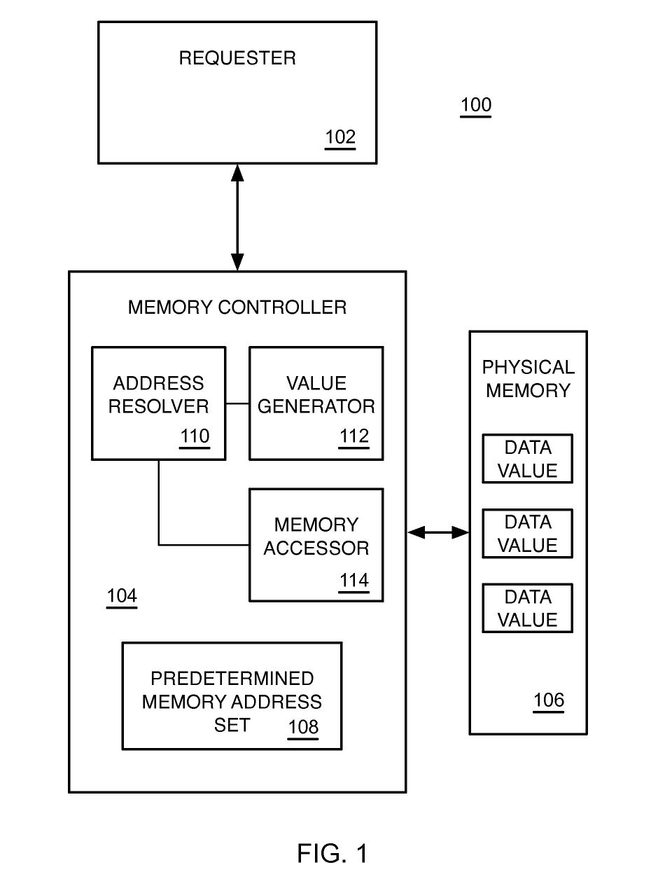

FIG. 1 depicts a functional block diagram of a portion of a processing system 100, e.g., a computer or other processor-based system, within which an embodiment is used. Processing system 100 comprises a requester 102, e.g., a processor, application specific integrated circuit, input/output (I/O) device, and/or other controlling device, etc., a memory controller 104, and a physical memory 106. Memory controller 104 is communicatively coupled with requester 102 and receives read and/or write requests and/or control signals from the requester and transmits read data values and/or control signals to the requester. Requester 102 transmits read and/or write requests to cause memory controller 104 to read and/or write a data value from/to a memory location in physical memory 106.

Memory controller 104 is communicatively coupled with physical memory 106. Responsive to receipt of a read request from requester 100, memory controller 104 transmits a request for a data value at a particular memory location (address) to physical memory 106. In turn, responsive to receipt of the read request from memory controller 104, physical memory 106 transmits the requested data value from the memory address to the memory controller. Memory controller 104 transmits the received requested data value to requester 102. For clarity and ease of reference, only a single requester, memory controller, and physical memory are discussed herein. In at least some other embodiments, more than one of the requester, the memory controller, and the physical memory are useable.

In accordance with at least some embodiments, memory controller 104 comprises a predetermined memory address set 108 to which the memory controller compares the memory address of a request from requester 102 prior to issuing a request to physical memory 106. If a request from requester 102 specifies a memory address within predetermined memory address set 108, memory controller 104 generates and transmits a predetermined data value to requester 102. In at least one embodiment, if the requested memory address is within predetermined memory address set 108, memory controller 104 does not transmit a request to physical memory 106.

In one or more embodiments, predetermined memory address set 108 may be a single value, a range of values, a sequence of values, a plurality of values, a threshold value, etc.

In one or more embodiments, the predetermined data value transmitted from memory controller 104 to requester 102 is a single value. In one or more embodiments, the predetermined data value is a user-specified value. In one or more further embodiments, the predetermined data value may be a series of data values, e.g., an incrementing or decrementing sequence of data values.

In one or more embodiments, the predetermined data value is a function based on at least a portion of the received request. For example, in one embodiment, memory controller 104 generates the predetermined data value by applying a function to the memory address of the request. In at least one embodiment, the function operates on the memory address of the request with respect to a particular memory address, e.g., an upper or lower limit of physical memory 106. In another embodiment, the function is a user-specified function. In further embodiments, the function applied may be based on one or more signals available to memory controller 104. For example, in at least one embodiment, memory controller 104 may return a value indicative of which portion of a cache line a requested address is related, e.g., the controller returns: a value of zero (0), if the requested address is in the first quarter of a cache line, a value of one (1), if the requested address is in the second quarter of a cache line, a value of two (2), if the requested address is in the third quarter of a cache line, etc.

If a request from requester 102 specifies a memory address outside predetermined memory address set 108, the memory controller transmits the request to physical memory 106. If the memory address of the request is within a range of physical memory 106, the physical memory handles the request, i.e., returns a data value from the memory address or writes a value to the memory address. In some embodiments, physical memory 106 generates and transmits a reply to memory controller 104 responsive to receipt of the request. If the memory address of the request is outside the range of physical memory 106, memory controller 104 determines an error has occurred. In at least one embodiment, memory controller 104 generates and transmits an error message to requester 102. In at least some embodiments, physical memory 106 transmits an error value to memory controller 104 in conjunction with the error message. In at least some further embodiments, physical memory 106 and/or memory controller 104 generate an error indication, e.g., driving a fault line of system 100, for requester 102 and/or system 100.

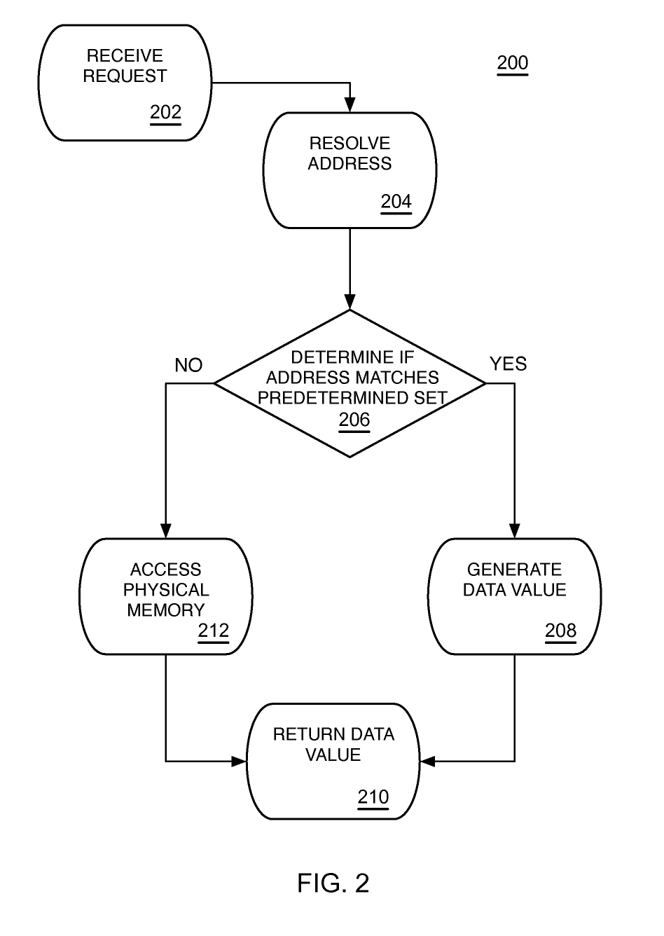

FIG. 2 depicts a high level process flow diagram of a portion 200 of the operation of memory controller 104 according to an embodiment. The process flow begins at receive request function 202 wherein memory controller 104 receives a memory request from requester 102, e.g., a read request comprising a memory address in physical memory 106 from which requester is requesting a data value. The flow proceeds to resolve address function 204.

Memory controller 104, executing resolve address function 204, determines the address specified in the memory request. The flow proceeds to determine match function 206 wherein memory controller 104 determines whether the resolved address from the memory request is within predetermined memory address set 108.

If the resolved address is within predetermined memory address set 108, the flow proceeds to generate value function 208. Memory controller 104, executing generate value function 208, generates a predetermined data value and the flow proceeds to return function 210. Memory controller 104, executing return function 210, returns the generated predetermined data value to requester 102.

Returning to determine match function 206, if the resolved address is outside predetermined memory address set 108, the flow proceeds to access memory function 212. Memory controller 104, executing access memory function 212, transmits the request to physical memory 106. Physical memory 106 returns a data value to memory controller 104 in response to the request and the flow proceeds to return function 210 and the flow proceeds as described above.

Returning to FIG. 1, memory controller 104 comprises an address resolver 110, a value generator 112, and a memory accessor 114. Address resolver 110 comprises functionality by which memory controller 104 retrieves an address from a memory request. At least a portion of address resolver 110 functionality comprises at least a portion of resolve address function 204.

In at least one embodiment, address resolver 110 comprises at least a portion of determine match function 206.

Value generator 112 comprises functionality by which memory controller 104 generates a data value for return to requester 102 if the address of the memory request is within predetermined memory address set 108. At least a portion of value generator 112 functionality comprises at least a portion of generate value function 208.

Memory accessor 114 comprises functionality by which memory controller 104 accesses physical memory 106 to obtain a data value if the address of the memory request is outside predetermined memory address set 108. At least a portion of memory accessor 114 functionality comprises at least a portion of access memory function 212.

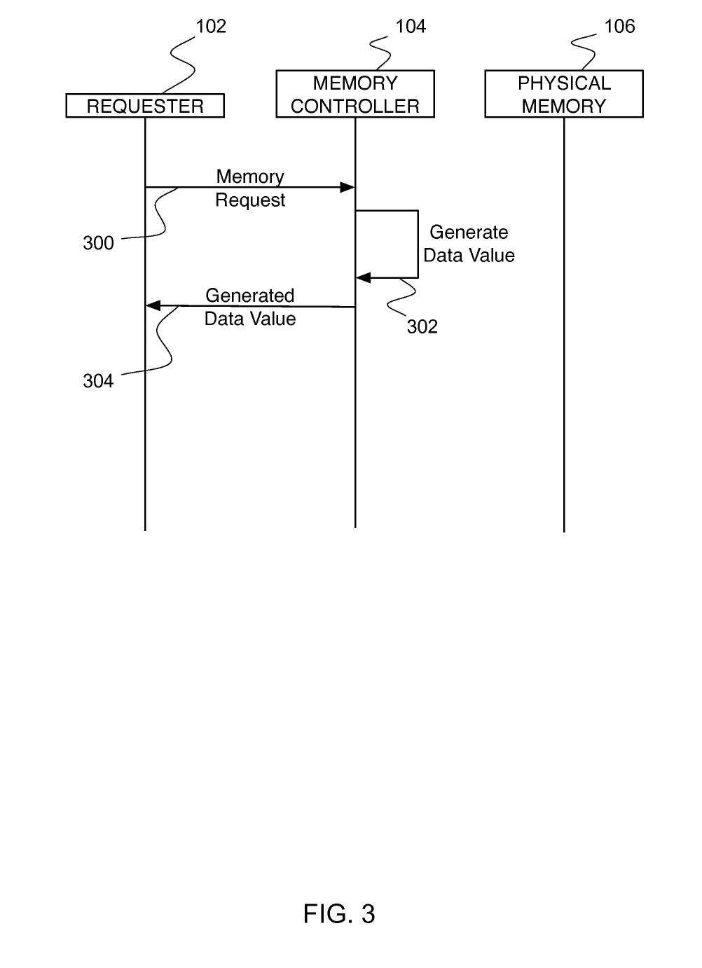

FIG. 3 depicts a message sequence diagram of operation of system 100 according to an embodiment. According to the embodiment, requester 102 generates and transmits a memory request to memory controller 104 (sequence 300) requesting a memory address within predetermined memory address set 108. Memory controller 104 determines that the memory address of the memory request from requester 102 is within predetermined memory address set 108 and generate a data value (sequence 302). Memory controller 104, responsive to generation of the data value, transmits the generated data value to requester 102 (sequence 304).

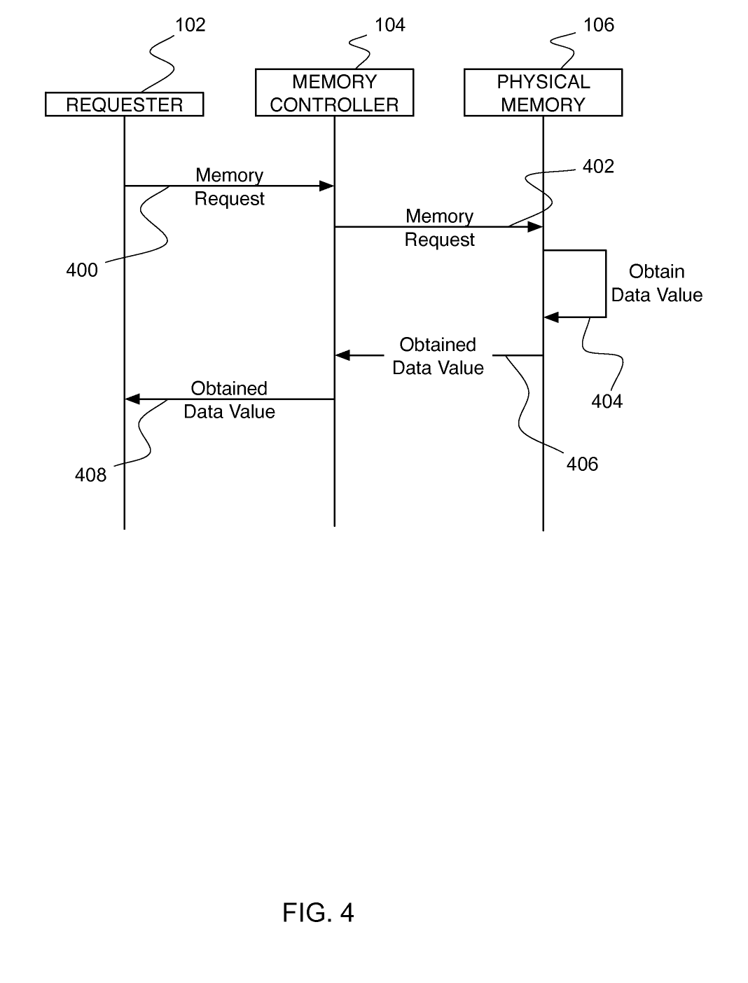

FIG. 4 depicts another message sequence diagram of operation of system 100 according to an embodiment. According to the embodiment, requester 102 generates and transmits a memory request to memory controller 104 (sequence 400) requesting a memory address outside predetermined memory address set 108. Memory controller 104 determines that the memory address of the memory request from requester 102 is outside predetermined memory address set 108 and transmits a memory request to physical memory 106 (sequence 402). Responsive to receipt of the memory request from memory controller 104, physical memory 106 obtains the data value from the requested memory address (sequence 404) and returns the obtained data value to memory controller 104 (sequence 406). Responsive to receipt of the obtained data value from physical memory 106, memory controller 104 transmits the obtained data value to requester 102 (sequence 408).

What is claimed is:

1. A memory controller for generating a data value, comprising:
an address resolver arranged to receive a data value request from a requester, wherein the data value request comprises a memory address and wherein the address resolver is arranged to determine if the memory address is within a predetermined memory address set;
a value generator arranged to generate a data value based on a data value request determined to comprise a memory address within the predetermined memory address set.

2. A memory controller as claimed in claim 1, further comprising:
a memory accessor arranged to access a physical memory address to obtain a data value based on the data value request determined to comprise a memory address outside the predetermined memory address set.

3. A memory controller as claimed in claim 1, wherein the predetermined memory address set comprises a discontiguous set of memory addresses.

4. A memory controller as claimed in claim 1, wherein the value generator is arranged to generate the data value based on a predetermined function applied to at least a portion of the request.

5. A memory controller as claimed in claim 4, wherein the predetermined function is applied to the memory address of the request.

6. A memory controller as claimed in claim 4, wherein the predetermined function is a configurable function.

7. A memory controller as claimed in claim 1, wherein the generated data value is a predetermined value.

8. A memory controller as claimed in claim 7, wherein the predetermined value is a user-specified value.

9. A memory subsystem handling data value requests, comprising:
a memory controller as claimed in claim 1 and having a memory address space;
a physical memory connected with the memory controller, wherein the physical memory address space is a subset of the memory address space of the memory controller.

10. A method of generating a data value at a memory controller, comprising:
receiving a data value request, wherein the data value request comprises a memory address;
determining if the memory address of the data value request is within a predetermined memory address set; and
generating a data value based on a data value request determined to comprise a memory address within the predetermined memory address set.

11. A method as claimed in claim 10, wherein the generating comprises:
generating the data value based on applying a predetermined function to at least a portion of the request.

12. A method as claimed in claim 11, wherein the predetermined function is applied to the memory address of the request.

13. A method as claimed in claim 11, wherein the predetermined function is a configurable function.

14. A method as claimed in claim 10, wherein the generated data value is a predetermined value.

15. A method as claimed in claim 10, wherein the generated data value is a configurable value.

16. A memory or a computer-readable medium storing instructions which, when executed by a memory controller, cause the memory controller to receive a data value request comprising a memory address, determine if the memory address of the data value request is within a predetermined memory address set, and generate a data value based on a data value request determined to comprise a memory address within the predetermined memory address set.

17. A memory or a computer-readable medium as claimed in claim 16, wherein the generate instructions, when executed by a memory controller, cause the memory controller to generate the data value based on applying a predetermined function to at least a portion of the request.

18. A memory or a computer-readable medium as claimed in claim 17, wherein the predetermined function is applied to the memory address of the request.

19. A memory or a computer-readable medium as claimed in claim 17, wherein the predetermined function is a configurable function.

20. A memory of a computer-readable medium as claimed in claim 16, wherein the generated data value is a predetermined value.
